(19) United States
(12) Patent Application Publication
(10) Pub. No.: US 2025/0215822 A1
(43) Pub. Date: Jul. 3, 2025

(54) CYLINDER HEAD AND AN INTERNAL COMBUSTION ENGINE SYSTEM

(71) Applicant: Volvo Truck Corporation, GÖTEBORG (SE)

(72) Inventors: Tommy Simonsson, STENUNGSUND (SE); Jan Eismark, GÖTEBORG (SE); Rickard Ehleskog, HISINGS BACKA (SE)

(21) Appl. No.: 18/979,900

(22) Filed: Dec. 13, 2024

(30) Foreign Application Priority Data
Dec. 27, 2023 (EP) 23220341.4

(51) Int. Cl. F02B 43/10; F02B 23/08; F02B 75/12

(52) U.S. Cl. CPC F02B 43/10; F02B 23/08; F02B 2075/125

(57) ABSTRACT

The present disclosure relates to a cylinder head for an internal combustion engine, the cylinder head including a gas inlet port for supplying gas to a combustion chamber of the internal combustion engine, and further having a combustion-chamber facing area, and a flow-guiding protruding portion disposed in, or at, the gas inlet port, wherein the flow-guiding protruding portion is configured to direct incoming gas in a direction towards at least one potentially hot zone at, or on, the combustion-chamber facing area of the cylinder head.

### CROSS REFERENCE TO RELATED APPLICATIONS

This application claims priority to European Patent Application No. 23220341.4, filed on Dec. 27, 2023, the disclosure and content of which is incorporated by reference herein in its entirety.

### TECHNICAL FIELD

The disclosure relates generally to a cylinder head for an internal combustion engine. The disclosure further relates to an internal combustion engine system for a vehicle, wherein the internal combustion engine system has an internal combustion engine having a cylinder head. The disclosure is applicable on vehicles, in particularly heavy-duty vehicles, such as e.g., trucks. However, although the present disclosure will mainly be described in relation to a truck, the internal combustion engine may also be applicable for other types of vehicles propelled by means of an internal combustion engine. In particular, the present disclosure can be applied in heavy-duty vehicles, such as trucks, buses, and construction equipment, but also in cars and other light-weight vehicles etc. Further, the internal combustion engine is typically a hydrogen internal combustion engine, however other fuels may also be possible to use in combination with the cylinder head, such as natural gas. The present disclosure may also be applied in other machines such as power generators and construction equipment. The present disclosure may further be applied in marine vessels or the like.

### BACKGROUND

Hydrogen-based internal combustion engines represent a promising opportunity in the pursuit of cleaner and more sustainable transportation solutions, including heavy-duty vehicles as well as marine vessels. Hydrogen, a clean and abundant fuel, is gaining attention as an alternative to traditional fossil fuels due to its potential to reduce greenhouse gas emissions. In internal combustion engines, hydrogen can be used as a combustion fuel, either in pure form or as a blend with conventional fuels, to power vehicles and generate mechanical energy. Such internal combustion engines may also be used in stationary systems, such as in power generators.

While hydrogen-based internal combustion engines hold promise, there is still a need for further development of the internal combustion engine in order to provide a reliable and efficient combustion of the fuel within the combustion chambers of the cylinders. For example, it would be desirable to further develop the cylinder head of a cylinder of the internal combustion engine in order to provide better performance and durability of the internal combustion engine system.

### SUMMARY

According to a first aspect of the disclosure, there is provided a cylinder head for an internal combustion engine, the cylinder head comprising a gas inlet port for supplying gas to a combustion chamber of the internal combustion engine, the cylinder head further having a combustion-chamber facing area, and a flow-guiding protruding portion disposed in, or at, the gas inlet port, wherein the flow-guiding protruding portion is configured to direct incoming gas in a direction towards at least one potentially hot zone at, or on, the combustion-chamber facing area of the cylinder head.

The first aspect of the disclosure may seek to enhance cooling of potentially hot zones at, or on, the cylinder head surface during operation of the internal combustion engine. More specifically, the disclosure may seek to avoid unintentional ignition within the combustion chamber of a pre-mixed internal combustion engine, such as a pre-mixed internal combustion engine. A technical benefit may include providing an active control of the incoming gas-flow (air or a mix of air and recirculated exhaust gas) towards one or more selected hot zones/areas at, or on, the combustion-chamber facing area, which e.g., is the surface of the cylinder head facing the combustion chamber of the cylinder, so as to allow the re-directed gas-flow to cool, surfaces, parts and/or components within the one or more hot zones (i.e., potentially hot zones) to cool down. Thereby, it becomes possible to provide an improved cooling of the potentially hot zone(s).

The proposed cylinder head may be particularly suitable for pre-mixed internal combustion engine systems fueled by a gaseous fuel. For examples, the proposed cylinder head may be particularly suitable for pre-mixed internal combustion engine systems fueled by a gaseous fuel such as a hydrogen fuel. In hydrogen ICE system, the proposed cylinder head design having the above flow-guiding protruding portion may further improve the cooling of potentially hot zones during the mixing process of hydrogen gas and compressed air prior to an ignition event, thereby avoiding pre-ignition. The proposed cylinder head may also be suitable for other types of hydrogen internal combustion engine systems fueled by a hydrogen fuel.

The combustion-chamber facing area of the cylinder head is typically an integral part of the surface of the cylinder head. The combustion-chamber facing area may also be a region that is defined by engine component arranged at, or in, the cylinder head.

In some embodiments, the at least one potentially hot zone may comprise an ignition device. A technical benefit may include providing a more precise cooling of the ignition device. Lowering the temperature of the ignition device, such as the spark plug, can contribute to improved performance. A cooler ignition device is less likely to cause pre-ignition or misfire, potentially also resulting in a more efficient combustion process.

In some embodiments, the at least one potentially hot zone may comprise a fuel injector part of a fuel injector. A technical benefit may include providing a more precise cooling of the fuel injector part, such as the tip of the fuel injector inside the combustion chamber, or the entire fuel injector. A cooler fuel injector is less likely to cause pre-ignition, potentially also resulting in a more efficient combustion process.

In some embodiments, the cylinder head may further comprise one or more exhaust gas ports. A technical benefit may include providing a less complex design of the ICE, in that placing the exhaust gas port(s) in the cylinder head may facilitate the overall design of the exhaust system. This can reduce the complexity of the exhaust manifold configuration and may result in a more straightforward and compact layout for the overall engine design.

In some embodiments, the at least one potentially hot zone may be defined by a region of the combustion-chamber facing area adjacent the one or more exhaust gas ports. A technical benefit may include providing a more precise cooling of selected hot zones at, or on, the cylinder head surface (combustion-chamber facing area). The exhaust gas from a hydrogen ICE can be warmer than the incoming air, especially considering the high combustion temperatures associated with hydrogen. Hence, the areas around the exhaust gas port(s) may typically be higher than other areas/regions of the cylinder head.

In some embodiments, the flow-guiding protruding portion may have a substantial extension in a radial direction of the gas inlet port and a substantial extension along a circumferential direction of the gas inlet port.

In some embodiments, the flow-guiding protruding portion may be provided in the form of an arc-shaped washer portion, the arc-shaped washer portion having a curvature being arranged and configured to direct gas in the direction towards the at least one potentially hot zone. A technical benefit with an arc-shaped washer portion may include providing an improved design of the flow-guiding protruding portion that is easy to implement and position in the inlet port.

In some embodiments, the flow-guiding protruding portion may be an integral part of a circular washer. A technical benefit with a circular washer may include providing a more comprehensive flow-guiding part, which may also be relatively easy to manufacture and attach to the inlet port.

The circular washer may have a curvature being arranged and configured to direct gas in the direction towards the at least one potentially hot zone. Alternatively, or in addition, the circular washer may comprise the arc-shaped washer portion providing the curvature.

In some embodiments, the flow-guiding protruding portion may be an integral part of the gas inlet port. A technical benefit may include providing a more favorable manufacturing and assembly of the cylinder head during production of the cylinder head and the ICE.

In some embodiments, the flow-guiding protruding portion may be a separate part that is configured to be attached at the gas inlet port. A technical benefit may include providing an improved modularity in design, allowing for greater flexibility and case of customization. A flow-guiding protruding portion provided as a separate part to the cylinder head, and which is then attached to the gas inlet port before use of the cylinder head in the ICE, may also allow for a potential upgrade or repair, if needed. For example, if a flow-guiding protruding portion needs improvement or replacement, it can be done without affecting the functionality of the rest of the cylinder head.

In some embodiments, the flow-guiding protruding portion may comprise a combustion-facing surface being flush with an inner surface of the cylinder head. A technical benefit may include providing a smoother arrangement and positioning of the flow-guiding protruding portion in the ICE.

According to a second aspect of the disclosure, there is provided an internal combustion engine, ICE, system comprising a cylinder head according to the first aspect of the present disclosure, the ICE system further comprising an ICE configured to be operable on a gaseous fuel, the ICE further having a cylinder, a reciprocating piston moveable in the cylinder, a combustion chamber at least partly defined by the cylinder head and the cylinder, and an ignition device configured to ignite the gaseous fuel within the combustion chamber.

The second aspect of the disclosure may seek to solve the same problem as described for the first aspect of the disclosure. Thus, effects and features of the second aspect of the disclosure are largely analogous to those described above in connection with the first aspect of the disclosure.

Whilst the present disclosure may be used in any type of ICE system that includes the proposed cylinder head, the present disclosure is particularly useful for a hydrogen-based internal combustion systems. Hence, according to at least one embodiment, the ICE system is a hydrogen ICE system.

In some embodiments, the ICE is a pre-mixed internal combustion engine operable on hydrogen.

In some embodiments, the ICE is a diffusion-based internal combustion engine operable on hydrogen.

In some embodiments, the ICE system may further comprise a fuel injector arranged at, or in, the cylinder head.

In some embodiments, the ICE system may further comprise a fuel injector arranged upstream the gas inlet ports.

The reciprocating piston may be arranged to be moveable within the cylinder between a bottom dead center BDC and a top dead center TDC, wherein the piston top end being arranged to form part of the combustion chamber.

According to a third aspect of the disclosure, there is provided a vehicle comprising a cylinder head according to the first aspect, and/or any one of the examples of the first aspect, and/or an internal engine combustion system according to the second aspect and/or any one of the examples of the second aspect.

The third aspect of the disclosure may seek to solve the same problem as described for the first to second aspects of the disclosure. Thus, effects and features of the third aspect of the disclosure are largely analogous to those described above in connection with the first and second aspects of the disclosure.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 schematically illustrates an exemplary vehicle, in the form of a truck, the vehicle comprising an internal combustion engine (ICE) system and ICE according to an example.

FIG. 2 is a side view of a cylinder, a cylinder head and a reciprocating piston of an ICE system according to an example.

FIG. 3 is a perspective view of a cylinder head according to an example.

FIG. 4 is a bottom view of a cylinder head according to an example.

FIG. 5 schematically illustrates an exemplary flow-guiding protruding portion of the cylinder head according to an example.

FIG. 6 schematically illustrates a number of examples of a cylinder head.

### DETAILED DESCRIPTION

The detailed description set forth below provides information and examples of the disclosed technology with sufficient detail to enable those skilled in the art to practice the disclosure.

For internal combustion engines operable on a gaseous fuel, such as a hydrogen-based fuel, there is typically a challenge in terms of combustion control, in particular in the context of pre-ignition. More specifically, hydrogen exhibits combustion characteristics that distinguish the fuel from traditional hydrocarbon fuels. Hydrogen has a wide flammability range, high flame speed, and low ignition energy. These properties contribute to rapid combustion and efficient energy release.

Pre-ignition occurs when the air-fuel mixture ignites before the scheduled spark ignition event. In the case of hydrogen-fueled ICEs, pre-ignition may be particularly problematic due to the fuel's propensity for rapid combustion. Hot areas within the combustion chamber, at the surface of the cylinder head, or residual gases from earlier combustion cycles can act as sources of heat, triggering premature ignition of the fresh fuel-air mixture.

By way of example, hot areas (or potentially hot zones) within the combustion chamber or at the cylinder head, such as at an ignition device (spark-plug), at the exhaust valve(s), or at the fuel injection, can elevate the temperature of the incoming gas, or incoming gas mixture, promoting pre-ignition.

In order to mitigate the sensitivity to abnormal combustion, in particular pre-ignition, a number of various systems and method have been developed, such as implementing effective cooling strategies for critical components and/or selecting materials with high thermal resistance to withstand the demands of hydrogen combustion.

However, there is still a need for improving cooling of potentially hot zones at, or on, the cylinder head surface facing the combustion chamber of the cylinder.

The disclosure thus seeks to enhance cooling of potentially hot zones at, or on, the cylinder head surface during operation of the internal combustion engine. More specifically, the disclosure may seek to avoid unintentional ignition within the combustion chamber of an internal combustion engine, such as a pre-mixed internal combustion engine, e.g., a pre-mixed hydrogen internal combustion engine.

A technical benefit may include providing an active control of the incoming gas-flow (air or a mix of air and recirculated exhaust gas) towards one or more selected hot zones/areas at, or on, the surface of the cylinder head facing the combustion chamber of the cylinder, so as to allow the re-directed gas-flow to cool surfaces, parts or components within the one or more hot zones (potentially hot zones) to cool down. Thereby, it becomes possible to provide an improved cooling of the potentially hot zone(s).

In particular, by arranging a flow-guiding protruding portion at, or in, a gas inlet port of the cylinder head, which is configured to direct incoming gas, such as fresh air, towards at least one potentially hot zone at, or on, a combustion-chamber facing area of the cylinder head, it becomes possible provide and control cooling to a specific localized area, without impairing the original cylinder flow.

In the context of the present disclosure, the term “hot zone” refers to an area (combustion-chamber facing area) at, or on, the cylinder head surface where combustion temperatures can be particularly high. The hot zone may typically form part of a combustion-chamber facing area of the surface of the cylinder head. For example, hydrogen combustion tends to produce higher flame temperatures compared to traditional hydrocarbon fuels like gasoline or diesel. In hydrogen ICE systems, the term “hot zone” is thus used to describe specific regions within the combustion chamber, particularly in the vicinity of the spark plug and/or fuel injector, where temperatures are significantly elevated during combustion. In a more detailed definition, the term “hot zone” refers to an area where combustion temperatures may be too high so that autoignition of the fuel may occur prior to the ignition event by the ignition source. A potentially hot zone is thus a zone having the potential to become hot under certain conditions, such as during combustion within the cylinder. Typically, the potentially hot zone can reach a temperature exceeding the autoignition temperature of the fuel, such as the autoignition temperature of hydrogen gas. Hydrogen has a wide flammability range in air (4% to 75%), and it can auto-ignite under certain conditions. Autoignition refers to the spontaneous ignition of a substance without an external ignition source.

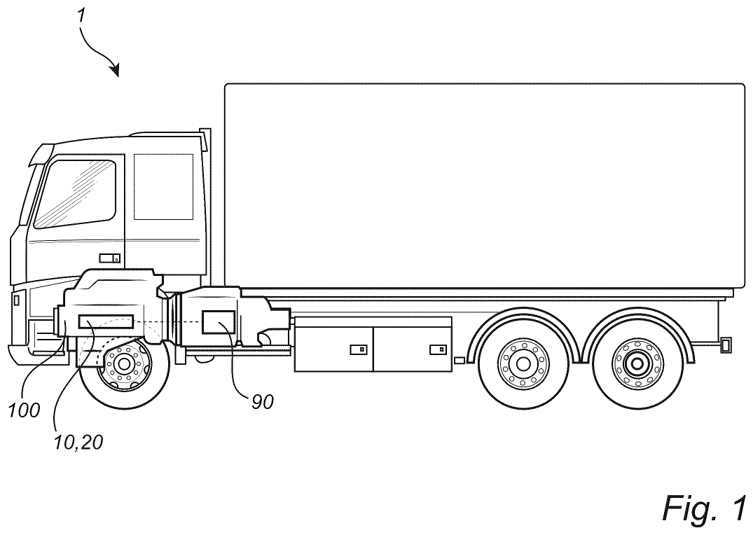

FIG. 1 is an exemplary embodiment of the present disclosure, comprising a side view of a vehicle 1, in the form of a truck, according to an example.

Whilst the shown example illustrates a truck, the disclosure may relate to any vehicle, such as a car, bus, industrial vehicle, marine vessel, boat, ship, etc., wherein motive power may be derived from an internal combustion engine.

The vehicle 1 comprises an internal combustion engine system 100. The internal combustion engine system may typically herein refer to the ICE system 100. The ICE, system 100 is arranged in the vehicle 1 so as to provide power to the vehicle 1 and driving the vehicle 1. The ICE system 100 in FIG. 1 also comprises an ICE 10. The ICE 10 is intended for combustion of a gaseous fuel. By way of example, the ICE 10 is intended for combustion of a hydrogen-based fuel. Hence, in one example, the ICE is operable on a hydrogen-based fuel, such as pure hydrogen gaseous fuel. However, the ICE 10 may also in other examples be provided in the form of a natural gas internal combustion engine, i.e., an ICE intended for combustion of natural gaseous fuel.

Moreover, in FIG. 1, the ICE 10 is a pre-mixed internal combustion engine (pre-mixed ICE). A pre-mixed ICE is a type of internal combustion engine in which the air and fuel are injected into the combustion chamber(s) of the cylinder(s) and then mixed within the combustion chamber (from start of injection) untiled forced ignition, e.g., by an ignition device in the combustion chamber. As such, in a pre-mixed combustion process, a homogeneous mixture of air and fuel is created prior to ignition, and the mixture then combusts simultaneously when ignited.

The ICE may alternatively be diffusion combustion ICE. Such ICE may be a conventional spark-ignition ICE, in which fuel is directly injected into the cylinder, and the air-fuel mixture is not as thoroughly pre-mixed as in a pre-mixed ICE. The components of such ICE systems are commonly known in the art and thus not detailed described herein.

In FIG. 1, the vehicle 1 comprises a single propulsion system where traction power is provided by the ICE system 100. However, the truck may likewise be a hybrid electric vehicle. By way of example, such hybrid electric vehicle may comprise a supporting electric propulsion system having at least one high-voltage battery and at least one traction electric machine, and further the ICE system 100. The ICE system 100 may also be used for other equipment such as construction equipment, marine applications, as power generators, etc.

Moreover, the vehicle 1 may also comprise a controller 90, as depicted in FIG. 1. The controller 90 is here part of a control system. The controller 90 is here an integral part of a main electronic control unit for controlling the vehicle 1 and various parts of the vehicle 1. The controller 90 is arranged in communication with the components of the ICE system 100, in particular the ICE 10. The controller 90 may be part of the ECU of the vehicle 1. The controller 90 comprises a processing circuitry configured to control the ICE system 100, as described herein.

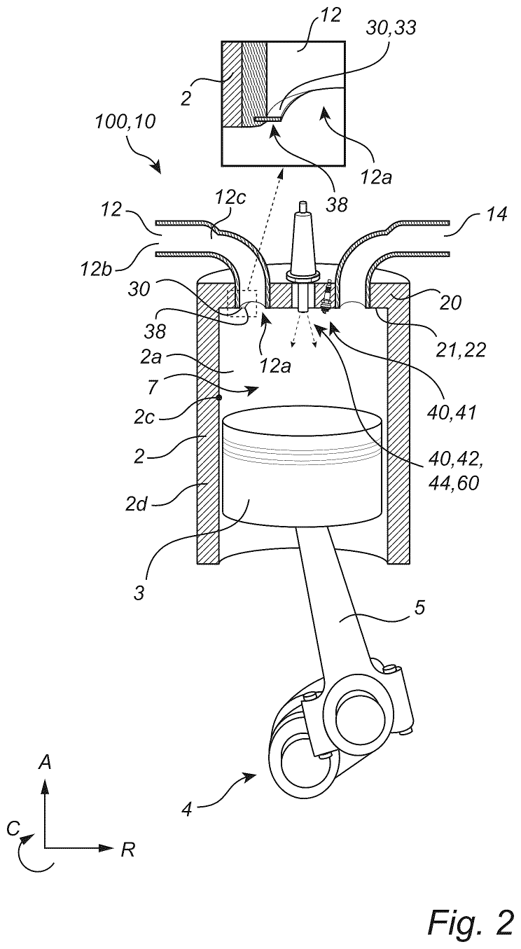

Turning now to FIG. 2, there is depicted one example of an ICE system 100 for incorporation in the vehicle 1 as described above in relation to FIG. 1. In particular, FIG. 2 is a perspective cross-sectional view of parts of an ICE according to examples of the disclosure. As illustrated in FIG. 2, the ICE 10 comprises a cylinder 2. Further, the ICE 10 comprises a cylinder head 20. In addition, the ICE 10 has at least one combustion chamber 7 at least partially defined by the cylinder 2 and the cylinder head 20. The cylinder 2 here also comprises a cylinder liner 2d.

The cylinder 2 here comprises the cylinder head 20. The cylinder head 20 may be an integral part of the cylinder 2. However, the cylinder head 20 is typically a part of the cylinder 2, which is arranged on the cylinder liner, so as to form the cylinder 2. Hence, as depicted in FIG. 2, the cylinder head 14 is a separate part that is connected to the cylinder 2, as is commonly known in the art.

It should be noted that the ICE 10 may comprise any number of cylinders. For example, the ICE 10 may comprise two, four, six, or eight cylinders. However, for simplicity and ease of reference, an example of the ICE 10, as well as the details of the cylinder and the cylinder head, is provided in relation to one cylinder.

Moreover, the ICE 10 comprises a piston 3. The piston 3 is arranged and configured to reciprocate inside the cylinder 2. In other words, the cylinder 2 is configured to accommodate the reciprocating piston 3. The piston 3 is arranged to reciprocate inside the cylinder 2 such that the ICE 10 is operated to combust fuel 60 (e.g., hydrogen), whereby the motion of the piston 3 reciprocating in the cylinder 2 is transmitted to a rotational movement of a crankshaft 4, as shown in FIG. 2. The ICE system 100 thus comprises the crankshaft 4. The piston 3 is connected to the crankshaft 4 by a conventional connecting rod 5, as illustrated in FIG. 2. The piston 3 also comprises a combustion-facing upper surface.

As mentioned above, the ICE 10 further comprises the cylinder head 20, as illustrated in FIG. 2. The cylinder head 20 is here an integral part of the cylinder 2. The cylinder head 20 has a surface 21. The surface 21 is here a combustion-facing surface, in particular a combustion-chamber facing surface. The surface 21 thus at least partly defines a combustion-chamber facing area 22. In other words, the combustion-chamber facing area 22 is here an integral part of the surface 21 of the cylinder head 20. In addition, or alternatively, the combustion-chamber facing area 22 is an area located at the surface 21. For example, the combustion-chamber facing area 22 comprises one or more engine components arranged at, or in, the cylinder head 20, such as an ignition device and/or a fuel injector.

The surface 21 of the cylinder head 20 at least partly defines the combustion chamber 7. By way of example, the surface 21 in combination with the cylinder 2 at least partly define the combustion chamber 7. Thus, the surface 21 is an inner surface 21 of the cylinder head 20. The inner surface 21 faces the combustion chamber 7 of the cylinder 2. For case of reference, the inner surface may be denoted as the surface 21.

More specifically, as depicted in FIG. 2, the cylinder 2 comprises a cavity 2a defining an inner volume. One end of the cylinder cavity 2a is closed by the cylinder head 20. Further, the cylinder 2 has an inner circumferential side wall 2c. In a similar vein, the cylinder head 20 has the surface 21, which is thus considered as an inner combustion-chamber surface (i.e., the combustion-chamber facing area 22). These parts together with a combustion chamber facing portion (such as the combustion chamber facing upper surface) of the piston 3 typically defines the combustion chamber 7, as depicted e.g., in FIG. 2.

Moreover, the combustion chamber 7 is arranged at an upper end portion of the cylinder 2, i.e., at the cylinder head 20 of the cylinder 2. The surface 21 of the cylinder 20 is thus an upper combustion chamber surface. Moreover, a top end of the piston 3 defines a lower combustion chamber surface.

In FIG. 2, the cylinder head 20 has an essentially flat (inner) surface 21. It should be noted that the cylinder head 20 may be provided in several different shapes, and thus not necessarily in the form of a flat surface 21. The cylinder head 20 may also be provided in the form of a so called pent-roof type. Other examples of cylinder heads are also possible. In addition, the inner wall 2c of the cylinder 2 may be provided by the cylinder liner, as is commonly known in the art.

It is to be noted that whilst FIG. 2 only depicts a single cylinder 2 having the cylinder head 20, the combustion chamber 7 and the reciprocating piston 3 arranged therein, the ICE 10 typically comprises a plurality of cylinders 2 operated to combust fuel 60, whereby the motions of the pistons 3 reciprocating in the cylinders 2 are transmitted to a rotational movement of the crankshaft 4. The crankshaft 4 is further coupled to a transmission (not shown) for providing a torque to driving elements. In case of a heavy-duty vehicle, such as the truck of FIG. 1, the driving elements are wheels.

For completeness, as illustrated in FIG. 2, the piston 3 is arranged in the cylinder 2 for reciprocal movement along a center axis. The piston 3 is mechanically connected to the crankshaft 4 of the ICE 10, so that the piston 3 is movable in the cylinder 2 between an upper dead center position and a lower dead center position. The piston 3 thus reciprocates in the cylinder 2 and is connected to the crankshaft 4 so that the piston 3 is set to reverse in the cylinder 2 at the upper and lower dead center positions. The upper dead center position is denoted as the top dead center, TDC, and the lower dead center position is denoted as the bottom dead center, BDC, as illustrated by the arrows in FIG. 2.

As used herein, the terms “radial” or “radially” refer to the relative direction that is substantially perpendicular to an axial centerline of a particular component. Further, the terms “longitudinal”, “longitudinally”, “axially” or “axial” refer to the relative direction that is substantially parallel and/or coaxially aligned to an axial centerline of a particular component. Also, the terms “longitudinal”, “longitudinally”, “axially” or “axial” refer to a direction at least extending between axial ends of a particular component, typically along the arrangement or components thereof in the direction of the longest extension of the arrangement and/or components. The terms “vertical” and “vertically” generally correspond to the axial direction. The axial direction is generally the same direction as the piston moves within the cylinder. Further, the terms “circumference”, “circumferential”, or “circumferentially” refer to a circumference or a circumferential direction relative to an axis, typically a central axis extending in the direction of the longest extension of the device and/or component.

As used herein, the terms “upstream” and “downstream” refer to the relative direction with respect to fluid flow in a fluid pathway. For example, “upstream” refers to the direction from which the fluid flows, and “downstream” refers to the direction to which the fluid flows. Accordingly, in this context, the terms upstream and downstream are generally defined relative to the flow of fuel from a fuel tank to the combustion chamber 7 of the cylinder 2, as illustrated in FIG. 2 and/or a flow of gas from an intake manifold to the combustion chamber 2, via an inlet port, such as the inlet port 12 of FIG. 2.

Similarly, terms such as “upper”, “above” and “top” as well as “floor”, “lower”, “bottom”, “below” generally refer to the relative position of the part or component with respect to the axial direction A.

The cylinder head 20 will hereinafter be described in relation to FIG. 2 and FIGS. 3 to 6.

As illustrated in FIG. 2, the cylinder 2 further comprises an ignition device 41. The ignition device 41 is arranged in the combustion chamber 7. The ignition device 41 is arranged in the cylinder 2 and at a location facing the combustion chamber 7. By way of example, the ignition device 41 is arranged at an upper end of the cylinder 2, as illustrated in FIG. 2. In particular, the ignition device 41 is arranged at the cylinder head 20 of the cylinder 2. As such, in FIG. 2, the cylinder head 20 comprises the ignition device 41. The ignition device 41 is one example of a potentially hot zone 40 of the cylinder head 20, as described herein. Hence, the ignition device 41 is an example of a hot zone of the combustion chamber 7. Other arrangements of the ignition device 41 are also conceivable.

The ignition device 41 is configured to ignite hydrogen gas supplied to the combustion chamber 7 of the cylinder 2. The hydrogen gas is supplied by means of a fuel injector 42, as further described herein. By way of example, the ignition device is a spark-plug 41. A spark plug is a device for delivering electric current from an ignition system to the combustion chamber of a spark-ignition engine to ignite the compressed fuel/air mixture by an electric spark, while containing combustion pressure within the engine.

However, the ICE 10 can use various types of ignition devices to initiate combustion in the air-fuel mixture within the cylinder 2. Other examples of ignition devices are e.g., glow plug, ignition coil, and so called coil-on-plug.

Turning again to FIG. 2, the cylinder head 20 also comprises a gas inlet port 12. The gas inlet port 12 is a gas intake port. The gas inlet port 12 is configured to be in fluid communication with the combustion chamber 7. Typically, the cylinder head 20 comprises a plurality of gas inlet ports 12. Hence, the cylinder head 20 comprises one or more gas inlet ports 12. Each one of the gas inlet ports 12 is arranged and configured to supply gas to a combustion chamber 7 of the ICE 10. The gas is here air. The gas may also be a combination of gas and exhaust gas, where exhaust gas is recirculated from the exhaust gas system to the intake manifold. Hence, the term incoming gas typically refers to air, fresh air and/or a mix of air and recirculated exhaust gases. The gas is a combustible gas. In some examples, the gas may also contain a mix of air and hydrogen gas (gaseous fuel). Such type of combustible gas is provided via the gas inlet port 12 when the ICE system 100 comprises a port injection fuel system.

The gas inlet port 12 has a fluid passage 12c, an opening 12b for receiving gas into the gas inlet port 12 and an outlet 12a for supplying gas from the gas inlet port 12 to the combustion chamber 7. Accordingly, the outlet 12a of the gas inlet port 12 is arranged at the combustion chamber 7. More specifically, the opening 12b of the gas inlet port 12 is arranged upstream the outlet 12a of the gas inlet port 12. In other words, the outlet 12a of the gas inlet port 12 is arranged downstream the opening 12b of the gas inlet port 12. The outlet 12a of the gas inlet port 12 is facing the combustion chamber 7.

Typically, the flow of gas through the gas inlet port 12 is controllable by an intake control valve (not illustrated). The intake control valve is arranged to open and close a fluid passage of the gas inlet port 12, thus controlling the flow of gas to the combustion chamber 7.

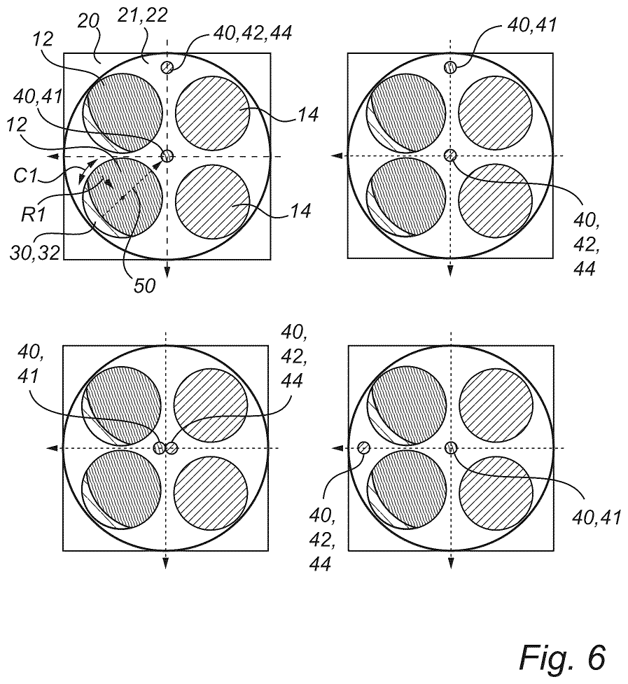

Moreover, as illustrated e.g., in FIG. 6, the gas inlet port 12 has an extension in the radial direction R1 and an extension in the circumferential direction C1.

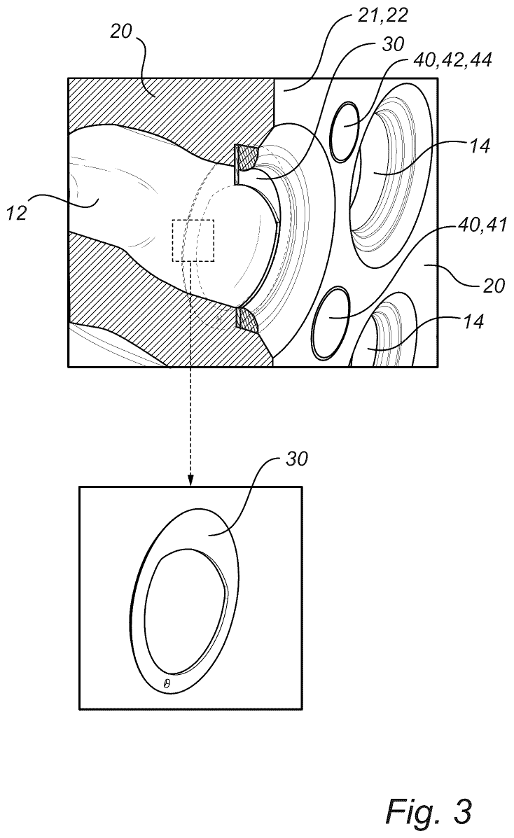

As illustrated in FIGS. 2 and 3, the cylinder head comprises a flow-guiding protruding portion 30. The flow-guiding protruding portion 30 is disposed in the gas inlet port 12. The flow-guiding protruding portion 30 is thus arranged in a gas flow through the gas inlet port 12. Hence, the gas inlet port 12 here comprises the flow-guiding protruding portion 30. In addition, or alternatively, the flow-guiding protruding portion 30 is disposed at the gas inlet port 12. Accordingly, the flow-guiding protruding portion 30 is disposed in, or at the gas inlet port 12.

The flow-guiding protruding portion 30 is configured to direct incoming gas in a direction towards at least one potentially hot zone 40 at, or on, the combustion-chamber facing area 22 of the cylinder 2. The potentially hot zone 40 is thus located at, or on, the surface 21 of the cylinder head 20.

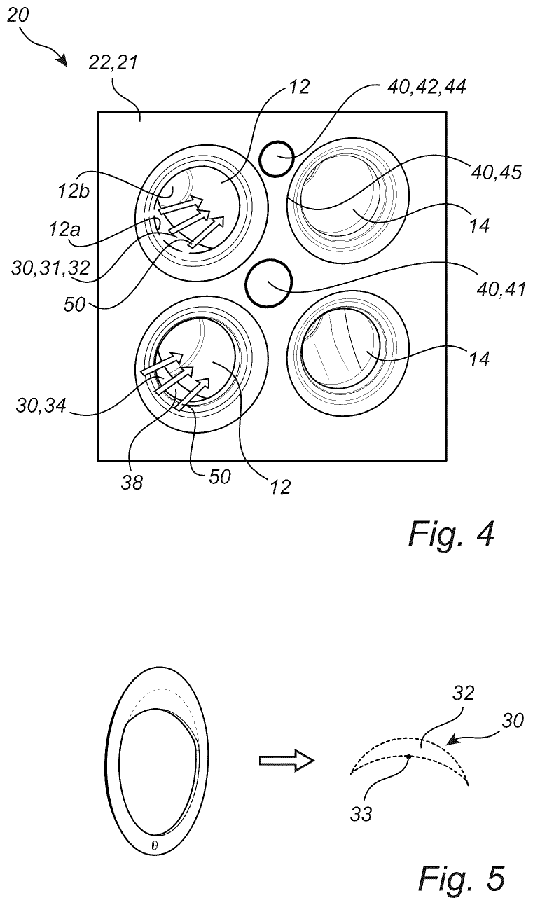

The flow-guiding protruding portion 30 is arranged in the gas flow of the inlet port 12. The flow-guiding protruding portion 30 is arranged and configured to change a direction of the incoming gas so as to redirect the gas flow towards the potentially hot zone 40 at, or on, the combustion-chamber facing area 22, e.g., the surface 21, of the cylinder head 20. In FIG. 4, the change of direction of the incoming gas is indicated by reference 50, in which the changed direction of the gas towards the hot zone 40 is indicated by reference 50.

The arrangement of the flow-guiding protruding portion 30 at, or inside, the gas inlet port 12 allows for an efficient way of changing the direction of the flow of gas 50 towards the hot zone 40, so as to provide a cooling effect on any component, surface or part, that is arranged within, or comprised within, the hot zone 40. Without the flow-guiding protruding portion 30 arranged at the gas inlet port 12, all incoming gas would flow towards the combustion chamber 7.

FIG. 4 in combination with FIG. 6 schematically illustrate a number of examples of the design and the arrangement of the flow-guiding protruding portion 30.

As illustrated in e.g., FIGS. 3 to 6, the flow-guiding protruding portion 30 is provided in the form of an arc-shaped washer portion 32. The arc-shaped washer portion 32 has a curvature 33 being arranged and configured to direct gas in the direction towards the at least one potentially hot zone 40. One example of a flow-guiding protruding portion 30 is illustrated in FIG. 5. In this example, the flow-guiding protruding portion 30 is an essentially circular washer having a protruding arc-shaped portion. As illustrated, the flow-guiding protruding portion 30 here comprises the arc-shaped protruding portion 32. The arc-shaped protruding portion has a curvature 33. The arc-shaped protruding curvature 33 provides for redirecting gas. More specifically, the arc-shaped protruding curvature 33 provides for changing a direction of a flow of gas when arranged at, or in, the gas inlet port 12, as illustrated e.g., in FIG. 3 and/or FIGS. 4 and 6. The arc-shaped protruding portion 32 here extends in the radial direction R1 of the gas inlet port 12, when arranged as e.g., illustrated in FIG. 6. As such, the flow-guiding protruding portion 30 has an extension in the circumferential direction and an extension in the radial direction.

Moreover, as illustrated in e.g., FIG. 6, when the flow-guiding protruding portion 30 is arranged at the gas inlet port 12, the flow-guiding protruding portion 30 has a substantial extension in the radial direction R1 of the gas inlet port 12 and a substantial extension along the circumferential direction C1 of the gas inlet port 12.

As such, as depicted e.g., in FIGS. 2 to 6, the flow-guiding protruding portion 30 comprises at least one region (such as the protruding portion 32 with the curvature 33) configured to receive incoming gas from the fluid passage 12c of the gas inlet port 12 and re-direct the gas at the outlet 12a of the gas inlet port 12 towards the potentially hot zone 40 at the combustion-chamber facing area 22, e.g., at, or on, the surface 21 of the cylinder head 20.

The curvature 33 should be positioned and designed in view of the position of the potentially hot zone 40. For example, the angle and position of the curvature is set based on the localization of the hot zone 40, which can vary for different types of cylinder heads 20.

In another example, the flow-guiding protruding portion 30 is provided in the form of a circular washer. The circular washer has a protruding portion 32 with a curvature 33 forming the region so that gas can be directed in the direction towards the potentially hot zone 40.

The flow-guiding protruding portion 30 can be a separate part 31, which is attached to the inlet port 12. Such configuration is schematically illustrated e.g., in FIG. 5.

The flow-guiding protruding portion 30 can also be an integral part of the cylinder head 20. FIG. 4 schematically illustrates the flow-guiding protruding portion 30 as an integral part 34 of the gas inlet port 12, while the other flow-guiding protruding portion 30 is a separate part 31 being securely attached to the gas inlet port 12, such as at the valve seat of the gas inlet port 12.

The cylinder 2 also comprises one or more exhaust gas ports 14, as depicted in e.g., FIG. 2. In this example, the cylinder head 20 comprises the one or more exhaust gas ports 14. The exhaust gas port 14 is configured to exhaust combusted gas from the cylinder 2. More specifically, the exhaust gas port 14 is configured to exhaust combusted gas from the combustion chamber 7.

For completeness, the ICE 10 typically comprises an air intake duct (not illustrated). The air intake duct is a manifold which is arranged and configured to feed intake air to the cylinder 2. The air intake duct is configured to be in fluid communication with the gas inlet port(s) 12.

In a similar vein, the exhaust port 14 is typically arranged in fluid communication with an exhaust duct. The exhaust duct is arranged to transport exhaust gas away from the cylinder 2 via the exhaust port(s) 14.

In addition, as illustrated in FIG. 2, the ICE 10 comprises a fuel injector 42. Typically, the cylinder 2 comprises the fuel injector 42. More specifically, the cylinder head 20 here comprises the fuel injector 42. The fuel injector 42 comprises a fuel injector part 44. The fuel injector 42 is configured to inject fuel 60 into the combustion chamber 7. The fuel 60 is a gaseous fuel 60, but may also be a liquid fuel. One example of a gaseous fuel is a hydrogen-based fuel. Other examples of fuels are LNG, LPG and the like. The fuel injector 42 is typically operable/controllable in response to a fuel injection event such that fuel injection is injected into the combustion chamber 7 for subsequent mixing of the gas, e.g., air, prior to ignition by means of the ignition device 41, and combustion within the combustion cylinder.

In particular, the fuel injector 42 is arranged at the cylinder head 20 of the cylinder 2. As such, in FIG. 2, the cylinder head 20 comprises the fuel injector 42. The fuel injector 42 41 is another example of a potentially hot zone 40 of the cylinder head 20, as further described herein. Hence, the fuel injector 42 is an example of a hot zone 40 of the combustion chamber 7. Other arrangements of the fuel injector 42 are also conceivable. By way of example, the fuel injector 42 may be arranged inside the cylinder head 20 in a recess, such that only the fuel injector tip (fuel injector part 44) is facing the combustion chamber 7. In such example, the fuel injector part 44 is an example of a potentially hot zone 40.

Turning again to the gas inlet port 12 and the arrangement of the flow-guiding protruding portion 30. FIGS. 3 and 6 discloses a number of different arrangements of the of the flow-guiding protruding portion 30.

In one example, as illustrated in FIGS. 4 and 6, the at least one potentially hot zone 40 comprises the ignition device 41. Accordingly, the ignition device 41 is arranged, or comprised, within the combustion-chamber facing area 22. In other words, the ignition device 41 here defines one hot zone 40 during use of the cylinder head 20 in the ICE 10. As such, by the arrangement and configuration of the flow-guiding protruding portion 30, it becomes possible to provide a more precise cooling of the ignition device 41.

In one example, as illustrated in FIGS. 4 and 6, the at least one potentially hot zone 40 comprises the fuel injector part 44 of the fuel injector 42. Accordingly, the fuel injector part 44 is arranged, or comprised, within the combustion-chamber facing area 22. It may also be possible that the entire fuel injector 42 is within the combustion-chamber facing area 22. In other words, the fuel injector part 44 of the fuel injector 42 here defines another hot zone 40 during use of the cylinder head 20 in the ICE 10. As such, by the arrangement and configuration of the flow-guiding protruding portion 30, it becomes possible to provide a more precise cooling of the fuel injector part 44.

In one example, as illustrated in FIGS. 4 and 6, the at least one potentially hot zone 40 is defined by a region 45 of the surface 21 being adjacent the exhaust gas port 14. Accordingly, the region 45 is arranged, or comprised, within the combustion-chamber facing area 22. In other words, the region 45 here defines yet another hot zone 40 during use of the cylinder head 20 in the ICE 10. As such, by the arrangement and configuration of the flow-guiding protruding portion 30, it becomes possible to provide a more precise cooling of the region 45, and thus a cooling of the material part of the cylinder head 20 at the exhaust gas port 14. Such cooling of the region 45 is advantageous as the exhaust gas from e.g., a hydrogen ICE can be warmer than the incoming air, especially considering the high combustion temperatures associated with hydrogen. Hence, the areas around the exhaust outlet port(s) 14 may typically be higher than other areas/regions of the cylinder head 14. Merely as an example, the temperature of the inlet air, incoming gas 50, may be about 70 degrees C., which is substantially lower than the temperature of the exhaust gases from combustion of hydrogen gas. In a hydrogen ICE, exhaust gas temperatures might range from approximately 300 to 500 degrees C.

As described herein, and as also illustrated in the FIGS. 2 to 6, the flow-guiding protruding portion 30 provides for designing the gas inlet port 12 to the combustion chamber 7 in such a way that the flow of gas will partly, or mainly, be directed to the one or more selected potentially hot zones 40, e.g., towards the sensitive components spark-plug 41 and the fuel injector tip 42. The flow-guiding protruding portion 30 is thus arranged and configured to actively direct the inlet gas-flow (air or a mix of air and recirculated exhaust) towards the selected hot zones 40, 41, 42, 44, 45 in the cylinder 2 to cool the components and/or areas within the hot zones to a lower temperature, thus potentially avoiding pre-ignition etc. Thereby, the cooling of the selected hot areas can be improved. The arrows 50 in FIGS. 4 and 6, indicates how the cooled air is directed by the flow-guiding protruding portion 30 so as to cool e.g., the spark plug 41 and the fuel injector tip 44.

The flow-guiding protruding portion 30 may also contribute to increasing the general turbulence of the ambient gas in the cylinder 2. Increased turbulence may have a positive impact on the mixing of the hydrogen and the ambient gas during the mixing period.

Moreover, another benefit with re-directing the flow of gas by means of the flow-guiding protruding portion 30 may be that large scale gas motions such as swirl around a cylinder center axis or a tumbling motion are generated. It should be noted, however, that the ICE system as described herein is generally a system without any original swirl-generating operation.

It is also possible that the combustion-chamber facing area 22 comprises several different hot zones 40, such as the ignition device 41, the fuel injector 42, the fuel injector part 44 and/or the region 45 of the outer part of the exhaust gas port 14.

In addition, in such example, the cylinder head 20 typically comprises a plurality of flow-guiding protruding portions 30, wherein each one of the flow-guiding protruding portions is arranged and positioned to direct corresponding gas towards a corresponding hot zone 40.

More specifically, as also illustrated in FIGS. 4 and 6, the cylinder head 20 is here provided with a number of two gas inlet ports 12. In a similar vein, the cylinder head 20 is here provided with a number of two exhaust gas ports 14. In some examples, the cylinder head 20 of the cylinder 2 may have a plurality of gas inlet ports 12 and a plurality of exhaust gas ports 14.

Each one of the gas inlet ports 12 comprises a corresponding flow-guiding protruding portion 30. Although not explicitly illustrated in e.g., FIG. 6, the flow-guiding protruding portions 30 are provided in different shapes and designs, and arranged at different positions around the circumferential direction C1 of respective gas inlet 12. In this manner, a number of flow-guiding protruding portions 30 can be used in the cylinder head 20 so as to provide cooling of a plurality of separated potentially hot zones 40, such as the fuel injector 42 (a first the zone) and the ignition device 41 (a second hot zone).

In FIG. 4, an additional potentially hot zone 40, 45 is illustrated. In this example, the hot zone 45 is the outer region of the exhaust gas port 14.

As also described herein, the flow-guiding protruding portion 30 is e.g., a separate part. That is, the flow-guiding protruding portion 30 is a loose part, which is separate from the cylinder head 20 prior to attachment of the flow-guiding protruding portion 30 at, or in, the gas inlet port 12. The flow-guiding protruding portion 30 is initially loose but then securely attached to the cylinder head 20 at, or in, the gas inlet port 12. Hence, the flow-guiding protruding portion 30 can be referred to as a “detachable” or “removable” component, that is subsequently fastened to the cylinder head 20 at, or in, the gas inlet port 12.

In such example, the flow-guiding protruding portion 30 is attached to the cylinder head 20. More specifically, the flow-guiding protruding portion 30 is attached to the gas inlet port 12 before use of the cylinder head 20 in the ICE 10. This type or arrangement allows for a potential upgrade or repair of the flow-guiding protruding portion 30. For example, if a flow-guiding protruding portion 30 needs improvement or replacement, it can be done without affecting the functionality of the rest of the cylinder head 20.

The flow-guiding protruding portion 30 can be fastened (attached) to the cylinder head 20 and in the gas inlet port 12 in several different ways, e.g., by welding, adhesive or the like. The flow-guiding protruding portion 30 may also be securely attached to the cylinder head 20 in the gas inlet port 12 by means of a threaded configuration.

In other examples, the flow-guiding protruding portion 30 is integrated into the structure forming the gas inlet port 12 at manufacturing of the cylinder head 20.

FIG. 2 also illustrates that the flow-guiding protruding portion 30 comprises a combustion-facing surface 38 being flush with the inner surface 21 of the cylinder head 20. In other examples, the flow-guiding protruding portion 30 comprises a combustion-facing surface 38 that may be located at least partly distanced from the surface 21 of the cylinder head 20.

Typically, the flow-guiding protruding portion 30 is arranged at the outlet 12a of the gas inlet port 12.

For example, the flow-guiding protruding portion 30 is arranged on the outlet 12a of the gas inlet port 12. In other examples, the flow-guiding protruding portion 30 is arranged slightly upstream the outlet 12a of the gas inlet port 12. For example, the flow-guiding protruding portion 30 is arranged downstream a seat valve (not illustrated) of the gas inlet port 12.

In some examples, the flow-guiding protruding portion 30 is also configured to create a swirl motion of the gas. In some examples, the flow-guiding protruding portion 30 is also configured to create a tumble motion of the gas. In some examples, the flow-guiding protruding portion 30 is also configured to balance global motion to a low swirl motion of the gas. In these examples, the flow-guiding protruding portion 30 is arranged to provide spot-cooling of one or more specific hot zone(s) 40 without impairing the original cylinder flow.

The flow-guiding protruding portion 30 is typically made of a material that has a relatively high resistance to high temperatures. The flow-guiding protruding portion may e.g., be made of a metal or any other suitable composite material, as is commonly known in the field of ICE systems including suitable materials for withstanding combustion of fuel.

The present disclosure also relates to the ICE system 100 comprising the cylinder head 20 according to the above examples. The ICE system 100 further comprises the ICE 10 configured to be operable on the gaseous fuel. Moreover, the ICE 10 further comprises the cylinder 2, the reciprocating piston 3 moveable in the cylinder 2, and the combustion chamber 7. The combustion chamber 7 is at least partly defined by the cylinder head 20 and parts of the cylinder wall 2a. The ICE 10 also comprises the ignition device 41 configured to ignite the gaseous fuel 60 within the combustion chamber 7. The reciprocating piston 3 is moveable within the cylinder 3 between the bottom dead center (BDC) and the top dead center (TDC). The piston top end is arranged to form part of the combustion chamber 7. The cylinder head 20 further comprises one or more gas inlet ports 12. At least one of the gas inlet ports 12 comprises the flow-guiding protruding portion 30, as described herein.

Moreover, in one example, the ICE 10 is a pre-mixed internal combustion engine operable on hydrogen. In another example, the ICE 10 is a diffusion-based internal combustion engine system operable on hydrogen.

Typically the ICE 10 comprises the fuel injector 42 arranged at the cylinder head 20. However, in other examples, the ICE system 100 may have a port fuel injection system, which means that the fuel injector is arranged upstream the gas inlet ports 12.

The ICE system 10 may further comprise an exhaust gas recirculation, EGR, system (not shown). The EGR system typically comprises an EGR conduit arranged to connect the exhaust duct and the air intake duct so as to permit recirculation of exhaust gas through the cylinder 2 during operation of the ICE 10. Accordingly, it may also be possible that the above gas inlet port 12 is configured to supply gas in the form of EGR gas into the combustion chamber 7.

The present disclosure also relates to the vehicle 1 comprising the ICE system 100 and the cylinder head 20 according to any one of the above examples in FIGS. 2 and 6.

Moreover, the present disclosure may be exemplified by any one of the below examples.

Example 1: A cylinder head 20 for an internal combustion engine 10, the cylinder head comprising a gas inlet port 12 for supplying gas to a combustion chamber 7 of the internal combustion engine, the cylinder head further having a combustion-chamber facing area 22, and further a flow-guiding protruding portion 30 disposed in, or at, the gas inlet port 12, wherein the flow-guiding protruding portion 30 is configured to direct incoming gas in a direction towards at least one potentially hot zone 40 at, or on, the combustion-chamber facing area of the cylinder head.

Example 2: Cylinder head of example 1, wherein the at least one potentially hot zone comprises an ignition device 41.

Example 4: Cylinder head of example 1 or example 2, wherein the at least one potentially hot zone comprises a fuel injector part 44 of a fuel injector 42.

Example 5. Cylinder head of any of the preceding examples, wherein the cylinder head further comprises one or more exhaust gas ports 14.

Example 63. Cylinder head according to example 4, wherein the at least one potentially hot zone is defined by a region 45 of the combustion-chamber facing area adjacent the one or more exhaust gas ports.

Example 7. Cylinder head of any of the preceding examples, wherein the flow-guiding protruding portion has a substantial extension in a radial direction R1 of the gas inlet port and a substantial extension along a circumferential direction C1 of the gas inlet port.

Example 8. Cylinder head of any of the preceding examples, wherein the flow-guiding protruding portion is provided in the form of an arc-shaped washer portion 32, the arc-shaped washer portion having a curvature being arranged and configured to direct gas in the direction towards the at least one potentially hot zone.

Example 9. Cylinder head of any one of examples 1 to 6, wherein the flow-guiding protruding portion is an integral portion of a circular washer. The circular washer has a curvature being arranged and configured to direct gas in the direction towards the at least one potentially hot zone.

Example 10. Cylinder head of any of the preceding examples, wherein the flow-guiding protruding portion is an integral part 34 of the gas inlet port.

Example 11. Cylinder head of any of the preceding examples, wherein the flow-guiding protruding portion comprises a combustion-facing surface 38 being flush with the inner surface 21 of the cylinder head.

Example 12. An internal combustion engine ICE system comprising a cylinder head according to any one of preceding claims, the ICE system further comprising an ICE configured to be operable on a gaseous fuel, the ICE further having a cylinder, a reciprocating piston moveable in the cylinder, a combustion chamber at least partly defined by the cylinder head and the cylinder, and an ignition device 41 configured to ignite the gaseous fuel within the combustion chamber.

Example 13. ICE system of example 12, wherein the ICE is a pre-mixed internal combustion engine operable on hydrogen.

Example 14. ICE system of example 12, wherein the ICE is a diffusion-based internal combustion engine system operable on hydrogen.

Example 15. ICE system of any one of examples 12 to 14, further comprising a fuel injector arranged at the cylinder head.

Example 16. ICE system of any one of examples 12 to 14, further comprising a fuel injector arranged upstream the gas inlet ports.

Example 17. A vehicle 1 comprising a cylinder head and/or an internal combustion engine ICE system of any of the preceding examples.

As used herein, the terms “upstream” and “downstream” refer to the relative direction with respect to fluid flow in a fluid pathway. For example, “upstream” refers to the direction from which the fluid flows, and “downstream” refers to the direction to which the fluid flows.

Also, the term “longitudinal”, “longitudinally”, “axially” or “axial” refer to a direction at least extending between axial ends of a particular component, typically along the arrangement or components thereof in the direction of the longest extension of the arrangement and/or components. The terms “vertical” and “vertically” generally correspond to the axial direction.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A cylinder head for an internal combustion engine, the cylinder head comprising a gas inlet port for supplying gas to a combustion chamber of the internal combustion engine, the cylinder head further having a combustion-chamber facing area, and a flow-guiding protruding portion disposed in, or at, the gas inlet port, wherein the flow-guiding protruding portion is configured to direct incoming gas in a direction towards at least one potentially hot zone at, or on, the combustion-chamber facing area of the cylinder head.

2. The cylinder head of claim 1, wherein the at least one potentially hot zone comprises an ignition device.

3. The cylinder head of claim 1, wherein the at least one potentially hot zone comprises a fuel injector part of a fuel injector.

4. The cylinder head of claim 1, wherein the cylinder head further comprises one or more exhaust gas ports.

5. Cylinder head according to claim 4, wherein the at least one potentially hot zone is defined by a region of the combustion-chamber facing area adjacent the one or more exhaust gas ports.

6. The cylinder head of claim 1, wherein the flow-guiding protruding portion has a substantial extension in a radial direction of the gas inlet port and a substantial extension along a circumferential direction of the gas inlet port.

7. The cylinder head of claim 1, wherein the flow-guiding protruding portion is provided in the form of an arc-shaped washer portion, the arc-shaped washer portion having a curvature being arranged and configured to direct gas in the direction towards the at least one potentially hot zone.

8. The cylinder head of claim 1, wherein the flow-guiding protruding portion is an integral part of a circular washer.

9. The cylinder head of claim 1, wherein the flow-guiding protruding portion is an integral part of the gas inlet port, or a separate part configured to be attached to the gas inlet port.

10. The cylinder head of claim 1, wherein the flow-guiding protruding portion comprises a combustion-facing surface being flush with an inner surface of the cylinder head.

11. An internal combustion engine (ICE) system comprising a cylinder head according to claim 1, the ICE system further comprising:
an ICE configured to be operable on a gaseous fuel, the ICE further having a cylinder, a reciprocating piston moveable in the cylinder, a combustion chamber at least partly defined by the cylinder head and the cylinder, and an ignition device configured to ignite the gaseous fuel within the combustion chamber.

12. The ICE system of claim 11, wherein the ICE is a pre-mixed internal combustion engine operable on hydrogen.

13. The ICE system of claim 11, wherein the ICE is a diffusion-based internal combustion engine system operable on hydrogen.

14. The ICE system of claim 11, further comprising a fuel injector arranged at, or in, the cylinder head.

15. The ICE system of claim 11, further comprising a fuel injector arranged upstream the gas inlet ports.

16. A vehicle comprising the internal combustion engine (ICE) system of claims 11.
